(19) United States
(12) Patent Application Publication
(10) Pub. No.: US 2004/0197530 A1
(43) Pub. Date: Oct. 7, 2004

(54) Packaging and insulating plastic sheet-like element

(76) Inventors: Fabio Angelo Gritti, Cologno Al Serio (IT); Roberto Gritti, Cologno Al Serio (IT)

Correspondence Address: MODIANO & ASSOCIATI, Via Meravigli, 16, 20123, MILANO, IT

(21) Appl. No.: 10/407,216

(22) Filed: Apr. 7, 2003

(51) Int. Cl. B32B 3/30

(52) U.S. Cl. 428/182

(57) ABSTRACT

A plastic sheet-like element, particularly for packaging, thermal and acoustic insulation and the like, comprising at least one continuous layer made of plastics, to which a body made of expanded plastic material is monolithically associated, the body having cavities adapted to reduce its weight.

### BACKGROUND OF THE INVENTION

The present invention relates to a plastic sheet-like element, particularly for packaging, thermal and acoustic insulation, and the like.

As is known, layers or panels made of expanded plastic material are currently commercially available and are used for manufacturing inserts, packaging padding, ordinary or special shock-absorbing padding, thermal and acoustic insulation structures, and so forth. Currently, expanded elements in sheet form are available in several materials, densities, formats and thicknesses, and for thicknesses up to 12-15 mm they are generally produced by extrusion or expansion, while for higher thicknesses up to approximately 150 mm they are produced by superimposing a plurality of layers and subjecting them to thermal bonding.

The result is a sheet that has a uniform and continuous internal structure and, by being solid, is relatively heavy and also has mechanical and elastic absorption characteristics that in many cases are not satisfactory.

Especially as regards packaging and thermal and acoustic insulation, in many cases it is necessary to have sheet-like elements having a particularly low density but are however capable of obtaining the intended characteristics of mechanical strength and elasticity.

### SUMMARY OF THE INVENTION

The aim of the invention is to eliminate the drawbacks noted above, by providing a plastic sheet-like element particularly for packaging, thermal and acoustic insulation and the like having a particular structure that allows to reduce the weight of the assembly and to increase the mechanical strength and elasticity properties.

Within this aim, an object of the invention is to provide a sheet-like element that is particularly versatile and capable of having the widest features as regards thermal and acoustic insulation and as regards impact absorption properties.

Another object of the present invention is to provide a sheet-like element that due to its particular constructive characteristics is capable of giving the greatest assurances of reliability and safety in use.

Another object of the present invention is to provide a plastic sheet-like element, particularly for packaging, thermal and acoustic insulation and the like, that can be obtained easily starting from commonly commercially available elements and materials and is further competitive from a merely economical standpoint.

This aim and these and other objects will become better apparent hereinafter are achieved by a plastic sheet-like element particularly for packaging, thermal and acoustic insulation and the like, according to the invention, characterized in that it comprises at least one continuous layer made of plastics, with which a body made of expanded plastic material is monolithically associated, said body having cavities adapted to reduce the weight of said body.

### BRIEF DESCRIPTION OF THE DRAWINGS

Further characteristics and advantages will become better apparent from the description of some preferred but not exclusive embodiments of a plastic sheet-like element particularly for packaging, thermal and acoustic insulation and the like, illustrated only by way of non-limitative example in the accompanying drawings, wherein:

FIG. 1 is a schematic exploded perspective view of a sheet-like element with a continuous layer and an undulated body;

FIG. 2 is a sectional view of the sheet-like element of FIG. 1;

FIG. 3 is a schematic exploded perspective view of a sheet-like element with two outer layers and an undulated body;

FIG. 4 is a sectional view of the sheet-like element of FIG. 3;

FIG. 5 is a partially exploded view of a sheet-like element with a body having a polygonal cross-section;

FIG. 6 is a sectional view of the sheet-like element of FIG. 5;

FIG. 7 is a schematic exploded perspective view of a sheet-like element with a grid-like body;

FIG. 8 is a sectional view of the sheet-like element of FIG. 7.

### DESCRIPTION OF THE PREFERRED EMBODIMENTS

With reference to the figures, the plastic sheet-like element particularly for packaging, thermal and acoustic insulation and the like according to the invention is obtained by using expanded plastic materials such as polyethylene, polypropylene, polyurethane, polystyrene and the like.

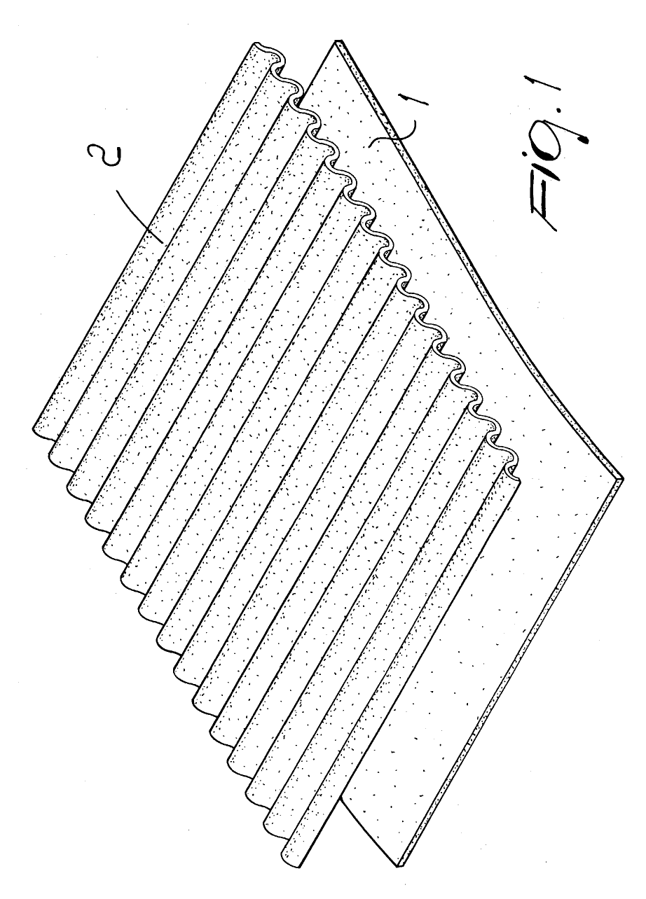

In order to produce the sheet-like element it is possible to use, as shown in FIGS. 1 and 2, a continuous layer 1, which is made of plastic material that is preferably but not necessarily expanded and with which an expanded plastic body 2 is monolithically coupled, said body being undulated so as to form a plurality of channels 5.

According to what is shown in FIGS. 3 and 4, it is possible to provide a sheet-like element 10 that is constituted by a first outer layer 11 and a second outer layer 12, which are made of expanded material and between which an undulated inner body 13 is interposed, forming a plurality of channels 15.

The body is made of a material that is identical to, or compatible with, the expanded plastic material of the outer layers, and forms a double plurality of through channels.

With reference to FIGS. 5 and 6, a sheet-like element 20 is shown in which there are first and second continuous outer layers 21 and 22, which are joined by an intermediate body 23 formed by means of inserts that allow to obtain channels 25 having a polygonal cross-section, for example any of a triangular, trapezoidal, square cross-section, and so forth.

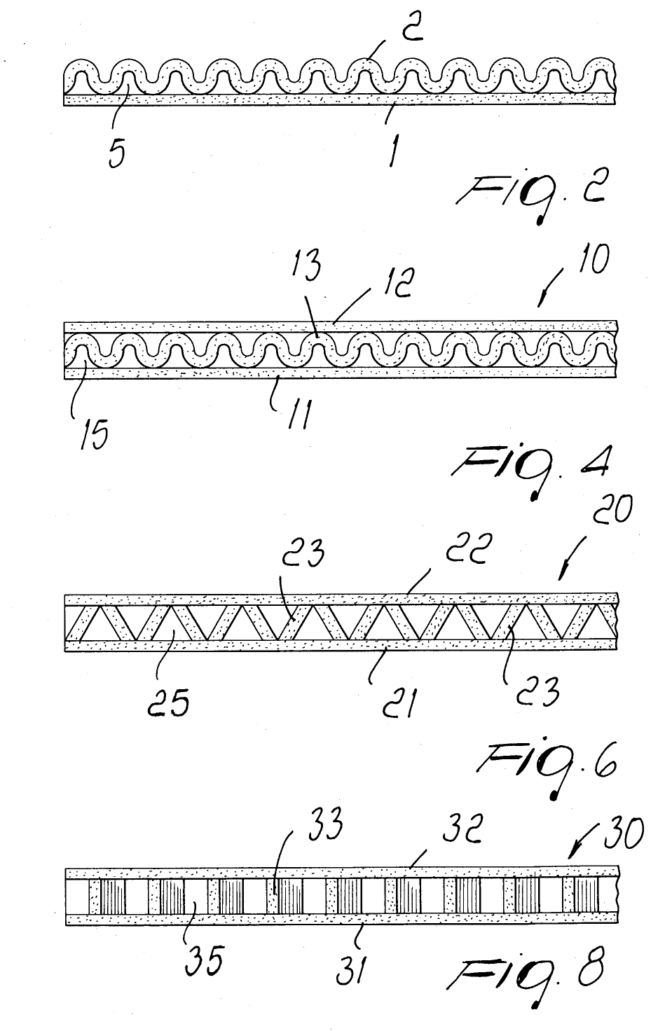

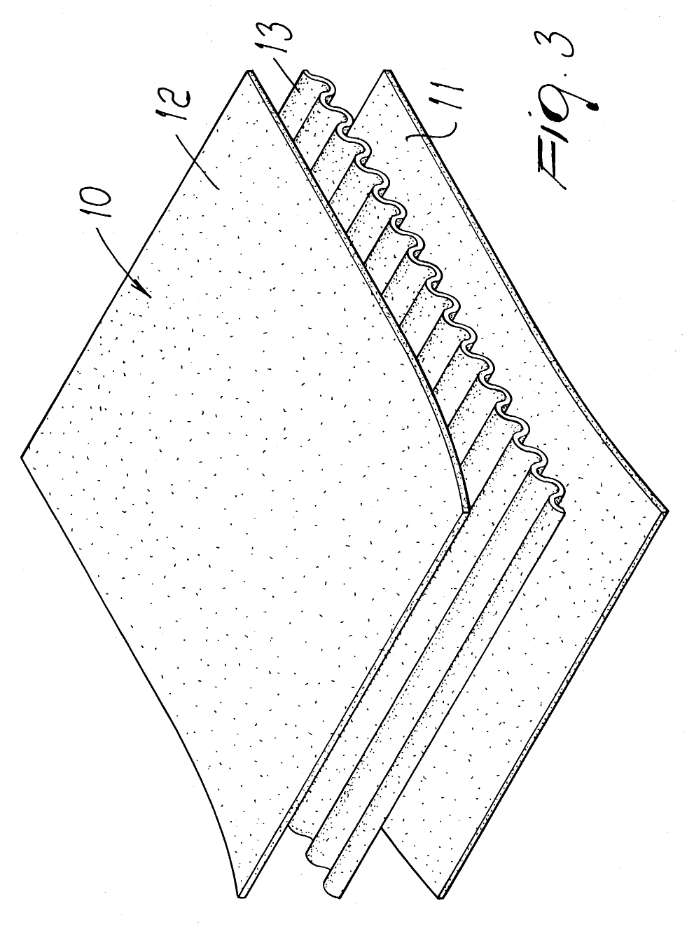

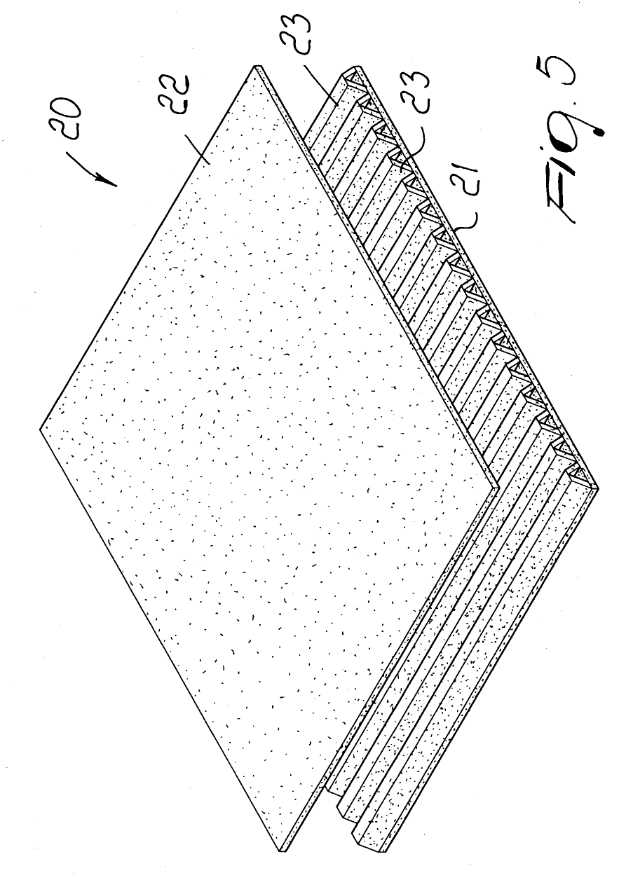

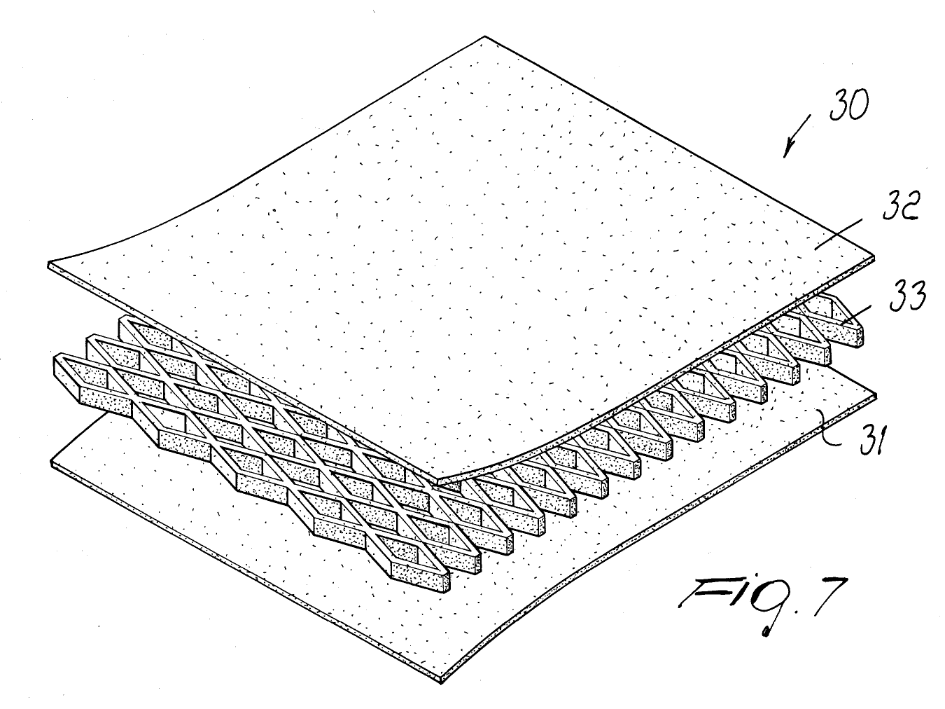

According to what is shown in FIGS. 7 and 8, the sheet-like element, generally designated by the reference numeral 30, is constituted by a first outer panel 31 and by an optional second outer panel 32, both connected to a lattice-like body 33 which is in practice grid-shaped, so as to form cavities 35 constituted by cells having any shape deemed appropriate.

With the arrangements described above it is possible to obtain a sheet-like element that is mechanically strong, by way of the coupling of a plurality of components, and is further capable of withstanding a variable load per unit surface according to the direction of the force relative to the arrangement of the internal structure of the sheet-like element; in practice, the values of compressive strength have behaviors similar to those of corrugated cardboard, and the pulling strength is close to the pulling strength of the original expanded plastic material.

This type of sheet-like element can be used to form packaging, since the body constitutes an element that undergoes deformation in order to obtain a shock-absorbing elastic effect that is particularly useful in case of packaging.

Furthermore, when using the sheet-like element as an element for thermal and acoustic insulation, a reduced density for equal thicknesses and surfaces is obtained, in practice increasing the volume and reducing the quantity of material, since air constitutes an excellent intermediate element.

Likewise, in the case of sheet-like elements with internal cells it is possible to provide different geometric shapes that allow to obtain a mechanical performance that is highly variable and can in any case be managed according to the intended shock-absorbing and protection requirements.

Among the shapes that have been found to be ideal, one should also consider the honeycomb or simple or crossed grid/net configuration, which produce good compactness of the final sheet-like element and a good reduction in density.

The arrangement and quantity of cells per unit surface are directly proportional to the strengths to be obtained for the final product.

Likewise, in case of insulation also, the space occupied is given priority over the quantity of material used, and it is therefore possible to always obtain optimum effects.

From the above description it is thus evident that the invention achieves the proposed aim and objects, and in particular the fact is stressed that a composite sheet-like element is produced which allows to reduce significantly its weight for an equal volume, thus increasing its impact absorption and thermal and acoustic insulation properties.

The invention thus conceived is susceptible of numerous modifications and variations, all of which are within the scope of the appended claims; thus, for example, the continuous layer can be provided in the form of a film having various densities and thicknesses.

All the details may further be replaced with other technically equivalent elements.

In practice, the materials used, as well as the contingent shapes and dimensions, may be any according to requirements.

What is claimed is:

1. A sheet element for packaging or thermal and acoustic insulation, comprising: at least one continuous layer made of plastic material; at least one body made of expanded plastic material which is monolithically associated with said at least one continuous layer, and cavities, provided at said body for reducing weight thereof.

2. The sheet element of claim 1, wherein said at least one continuous layer is made of expanded plastic material.

3. The sheet element of claim 1, comprising: a first outer layer made of expanded plastic material; a second outer layer made of expanded plastic material; and a said body interposed between said first and second outer layers.

4. The sheet element of claim 3, wherein said body is constituted by an undulated sheet element.

5. The sheet element of claim 3, wherein said body is constituted by inserts that are arranged adjacent and form cavities that have a polygonal cross-section.

6. The sheet element of claim 3, wherein said body is constituted by a grid structure.

7. The sheet element of claim 3, wherein said cavities are constituted by channels that extend substantially parallel to each other.

8. The sheet element of claim 3, wherein said cavities are constituted by channels that have a polygonal cross-section.

9. The sheet element of claim 3, wherein said cavities are constituted by cells.
